(19) United States
(12) Patent Application Publication
(10) Pub. No.: US 2011/0219621 A1
(43) Pub. Date: Sep. 15, 2011

(54) Hair Removal Device

(76) Inventors: Terence Gordon Royle, Basingstoke (GB); Lee Burrowes, Horsell, Woking (GB); Sean Peter Clarke, Highmoor Cross (GB); Christopher Martin Hawes, Reading (GB)

(21) Appl. No.: 13/047,931

(22) Filed: Mar. 15, 2011

Related U.S. Application Data
(60) Provisional application No. 61/340,299, filed on Mar. 15, 2010.

(51) Int. Cl. B26B 21/44

(52) U.S. Cl. 30/41; 30/535

(57) ABSTRACT

The invention features a hair removal device, such as a razor for dispensing a fluid during use. The hair removal device includes a fluid dispensing member which comprises an elongated elastomeric contact member for dispensing the fluid onto the skin in a wide and flat layer of fluid.

### CROSS REFERENCE TO RELATED APPLICATIONS

This application claims the benefit of U.S. Provisional Application No. 61/340,299 filed Mar. 15, 2010.

### BACKGROUND OF THE INVENTION

Product dispensing razors are known. These devices typically include one or more product dispensing ports to dispense product through the razor cartridge onto the face when in use. See, e.g., U.S. Patents Publications 2006/00240380 to Chenvainu et al; 2007/0084074 to Szczepanowski et al; U.S. Pat. Nos. 7,127,817; 7,121,754; and 6,789,321. Other attempts to dispense fluids out of razors include devices with product dispense ports dispensing directly out of some portion of the razor handle for a two hand operation during use. See, e.g., U.S. Pat. Nos. 5,701,674, and 5,070,611.

There remains a need for a hair removal device such as a product dispensing razor or a depilatory with a scraping edge, capable of depositing product in varying widths to precede the razor cartridge during a shaving stroke, without requiring two hand operation.

### SUMMARY OF THE INVENTION

One aspect of the present invention provides a hair removal device comprising: a handle having a length that extends from a proximal end to a distal end and a transverse centerline, the handle comprising a cavity for housing a fluid disposed within the handle, and a actuator adapted to displace the fluid from the cavity through a supply channel to an opening formed in said handle; a fluid dispensing member comprises an elongated elastomeric contact region forming at least one dispensing orifice, said fluid dispensing member extending out of said opening, said elongated elastomeric contact region comprising a lateral dimension which is generally perpendicular to said transverse centerline, wherein said fluid dispensing member is in fluid communication with said cavity via said opening, forming a fluid dispensing path, wherein said supply channel and said fluid dispensing path form a fluid flow path; at least one one-way valve located at some point along said fluid flow path; and a hair removal head having a lateral dimension. In one embodiment, the fluid dispensing member is positioned below the hair removal head when used in a downward stroke. This allows the fluid to be applied to skin to form a treated surface immediately prior to contact between the treated surface and the hair removal head.

The present invention addresses one or more of the problems encountered with known product dispensing hair removal devices by a fluid dispensing member comprising a fluid dispensing member comprises an elongated elastomeric contact region forming at least one dispensing orifice, and a one-way valve, said fluid dispensing member extending out of an opening connected to a cavity within the handle, said elongated elastomeric contact region comprising a lateral dimension which is generally perpendicular to said transverse centerline, wherein said fluid dispensing member is in fluid communication with said cavity via said opening. In one embodiment, the elongated elastomeric contact region forms said at least one one-way valve such that an elongated elastomeric one-way valve is formed. In one embodiment, the at least one one-way valve is selected from a flap valve, a slit valve, a duckbill valve, or a combination thereof.

In yet another embodiment, the invention features a method of dispensing fluid from a wet or dry hair removal device, such as a shaving razor, during the hair removal process via said elongated one-way elastomeric valve onto skin. Wet razors typically use linear blades, whereas dry razors typically use rotary blades or oscillating blades. The method includes actuating a pump thereby displacing the fluid from the cavity through the opening into and through fluid dispensing member and out to the dispensing orifice(s).

### BRIEF DESCRIPTION OF THE DRAWINGS

FIG. 1 is a side view of a hair removal device in accordance with at least one embodiment of the present invention;

FIG. 2 is a side view of a hair removal device in accordance with at least one embodiment of the present invention;

FIG. 3 is a side view of a hair removal device in accordance with at least one embodiment of the present invention;

FIG. 4 is a side view of the hair removal device shown in FIG. 3, but where the device is in use on a segment of skin; FIG. 5 is a bottom planar view of a hair removal device in accordance with at least one embodiment of the present invention

FIG. 6 is a bottom planar view of a hair removal device in accordance with at least one embodiment of the present invention; and

FIG. 7 is a bottom planar view of a hair removal device in accordance with at least one embodiment of the present invention.

FIG. 8 is an exploded side view of portion of a fluid dispensing member in accordance with at least one embodiment of the present invention.

FIG. 9 is a planar view of the contact region of the fluid dispensing member.

### DETAILED DESCRIPTION OF THE INVENTION

Certain implementations of the invention may include one or more of the following features. Typically, the fluid is stored in the cavity in a sachet, which can be replaceable or refillable. The fluid dispensing member may be partially integrally formed with the cartridge connecting structure or the handle. The fluid dispensing member may extend to or adjacent to the bottom portion of the hair removal head allowing for direct contact to a user during application of the hair removal head to skin, such as during a shaving stroke. The fluid dispensing member comprises a fluid dispensing member comprising at least one elongated elastomeric contact region. In one embodiment, the fluid dispensing member also comprises a one-way valve, which can be formed from said elongated elastomeric contact region. Nonlimiting examples of suitable one-way valves include: check valves such as diaphragm check valves, swing check valves or tilting disc check valves, stop-check valves, lift-check valves, flap valves, slit valves, and/or a duckbill valve (the latter three being particularly suitable if the one-way valve is formed in the region of the fluid dispensing member which contacts skin during use.) Those of skill in the art will understand that the elastomeric material forming the flap valve, slit valve or duckbill valve is such that upon contact with skin, the valve will deform and allow said one or more dispensing orifice(s) to allow fluid to dispense. In one embodiment, the fluid dispensing member forms at least one, but optionally two or more dispensing orifices at the dispensing end of the elongated elastomeric contact member for delivering said fluid from the cavity onto skin prior to hair removal. To prevent the fluid from leaking, the fluid flow path, along with any or all of the dispensing orifice(s) may comprise a check valve.

### Hair Removal Head

The hair removal head can include a wide scraping surface such as where the hair removal device is used with a depilatory, or a razor cartridge where the device is a shaving razor. The hair removal head may be replaceable or pivotally connected to a cartridge connecting structure. In an aspect, the cartridge connecting structure includes at least one arm to releasably engage the hair removal head.

Where the hair removal head is a razor cartridge the cartridge may also include multiple blades. For example, U.S. Pat. No. 7,168,173 generally describes a Fusion® razor that is commercially available from The Gillette Company which includes a razor cartridge with multiple blades. Additionally, the razor cartridge may include a guard as well as a shaving aid. A variety of razor cartridges can be used in accordance with the present invention. Nonlimiting examples of suitable razor cartridges, with and without fins, guards, and/or shave aids, include those marketed by The Gillette Company under the Fusion®, Venus® product lines as well as those disclosed in U.S. Pat. Nos. 7,197,825, 6,449,849, 6,442,839, 6,301,785, 6,298,558; 6,161,288, and U.S. Patent Publ. 2008/060201.

### Fluid Dispensing Member

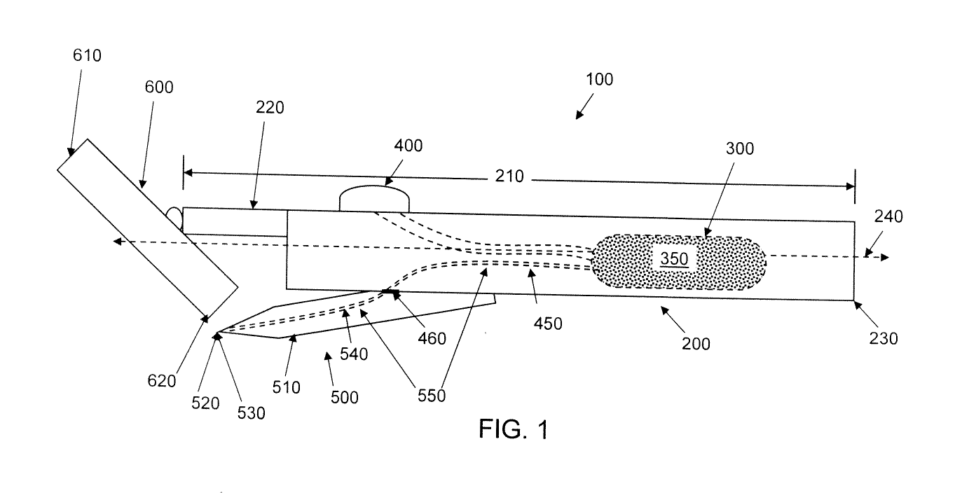

The fluid dispensing member of the present invention comprises an elongated elastomeric contact region. Non-limiting examples of suitable elongated elastomeric contact regions include: dual slit or duckbill valves such as those described in U.S. Patent Pub. 2006/00240380 in FIGS. 1-9 and paragraphs 52 to 58. The present invention, however, does not require dual lumens to be present, further, the present fluid dispensing member is designed to deliver fluid away from, preferably preceding, the head area of the personal care devices disclosed in the past. By delivering fluid prior to the skin contacting the hair removal head, it allows for broader spreading of the fluid and additional time where the fluid can come into contact with the folds and crevices within the skin. In one embodiment, the fluid dispensing member further comprises a non-elastomeric portion which can precede said elongate elastomeric contact member. The non-elastomeric portion can be formed of the same material as used to form any part of the remainder of the handle. In one embodiment, the one-way valve is not formed in said elongated elastomeric contact member. The one-way valve can be formed in the non-elastomeric portion of said fluid dispensing member or can be formed in any portion of said fluid flow path, such as in the supply channel, at the opening, and/or in the fluid dispensing path.

In one embodiment, at least a portion of the interior surface of the fluid flow path forms at least one rib, at least one channel, or a combination of ribs and channels, which run lengthwise along at least part of the length of the fluid flow path. In one embodiment, a plurality of ribs and/or channels are provided. A “rib” as defined herein means a protrusion which runs along a surface. A “channel” as defined herein means a recess running along a surface. These ribs and/or channels can be straight lines, or then can curl around the inner surface of the fluid flow path like the riffling of a fire arm barrel. Without intending to be bound by theory, it is believed that said at least one ribs and/or channel helps direct fluid towards the at least one dispensing orifice. Where the fluid flow path comprises at least one riffled ribs and/or channel, the curling motion may also help mix any fluid as it travels through the fluid flow path.

In one embodiment, at least a portion of the fluid dispensing member comprises one or more ribs and/or channels on the exterior surface of the fluid dispensing member. The one or more ribs and/or channels can run lengthwise along at least part of the length of the exterior of the fluid dispensing member. The ribs and/or channels can also form curved or wavy lines. Without intending to be bound by theory, it is believed that providing these ribs and/or channels can help direct any fluid when over stroking. It is believed that the ribs and/or channels can help direct any fluid which is already present on the skin to be directed under the fluid dispensing member through to the hair removal head, rather than be pushed out of the way. In one embodiment, the ribs and/or channels could also be positioned such that it is desiend to direct any already present fluid out of the way. Those of skill in the art will also understand that other texturing techniques can also be used in addition or in place of the ribs and/or channels.

“Elongated” as defined herein means, that the object has a major and a minor axis, wherein the major axis is at least 10 times larger than the minor axis. The elongated portion of the fluid dispensing member has a width (major axis) which is at least 10 times larger than the height. In one embodiment, the width measures from about 2 cm to about 15 cm, alternatively from about 3 cm to about 10 cm, alternatively from about 4 cm to about 8 cm. In another embodiment, the height of the elongated one-way elastomeric valve is about 1 cm, alternatively about 0.5 cm, alternatively from about 0.2 cm, alternatively the elongated one-way elastomeric valve is biased to be in a sealed orientation when not in use. Those of ordinary skill in the art will understand that a check valve may be used in embodiments where the elongated one-way elastomeric valve is not sealed when not in use to minimize product leakage. In another embodiment, the fluid is chosen such that even if the height of the valve is such that it remains unsealed and open when not in use, the fluid is sufficiently viscous and thick that it will not undesirably leak when not being actuated by the user. Those of skill in the art will understand that the elongated shape of the elastomeric region of the fluid dispensing member allows the user to deposit a relatively wide and flat layer of fluid onto skin during use. This is particularly desirable compared to fluid dispensing razors which have generally round or non-elongated dispensing holes which would be more likely to dispense fluid as drop or bead line.

“Elastomeric” as defined herein means a material which is generally flexible and deformable. In one embodiment, the elongated elastomeric contact member has a young's modulus of elasticity of from about 0.01 GPa to about 3.5 GPa, alternatively from about 0.02 GPa to about 2 GPa, alternatively from about 0.05 GPa to about 1 GPa, alternatively from about 0.1 GPa to about 0.5 GPa. Non-limiting examples of suitable materials which can be used to form the elastomeric contact member include rubber, silicone, Teflon, and polyethylene. Without intending to be bound by theory, it is believed that by providing an elastomeric material in the fluid dispensing member at the point where the fluid dispensing member would contact skin is particularly useful as it decreases irritation onto skin from a non-elastomeric fluid dispensing member. Further, the elastomeric material allows the tip of the fluid dispensing member to deform to better engage the non symmetric shape of body parts. In one embodiment, the elastomeric material used has a shore hardness of from about 30 to about 40 D units.

“Slit valve” as defined herein means that the valve comprises a closed slit and flow is provided by flexing or deformation of the elastomeric material which causes the slit to open. In general the slit valve is a single piece construction which is free of moving parts. “Duckbilled valve” as defined herein is a type of slit valve, wherein one end of the valve is stretched over the outlet of the fluid dispensing path, conforming itself to the shape of the path, usually round. The other end, the duckbill, retains a natural flattened shape. When a fluid is pumped through the fluid dispensing path, the duckbill's flattened end opens to permit the pressurized fluid to pass. When pressure is removed, however, the duckbill end returns to its flattened shape, preventing backflow. Other check valves referred to herein are known in the art.

“Generally perpendicular” as defined herein means that the lateral dimension of the elongated elastomeric contact region forms an angle which is from about 75° to about 90° as measured against the transverse centerline passing through the handle. Since the elongated elastomeric contact region is generally elastic and therefore deformable in nature, this angle is measured when the fluid dispensing region is at rest and not deformed or otherwise manipulated by a user. The elongated elastomeric contact region comprises a contact point where the fluid dispensing member engages the surface (skin). In one embodiment, the contact point forms a straight line. In another embodiment, the contact point forms a concave or convex line. Similarly, “generally parallel” as defined herein means that the two straight lines formed through said objects are parallel or form an angle of from about 0° to about 15° when in a resting position.

The fluid flow path terminates at least one fluid dispensing orifice. In one embodiment, more than one fluid dispensing orifice is provided. The fluid dispensing orifice is formed of the elastomeric material used to form the elongated elastomeric contact member. Preferably, the fluid dispensing orifice has a wide and narrow shape similar to the fluid dispensing member but the fluid dispensing orifice can also be of different shapes. In one embodiment, the fluid dispensing member comprises a plourality of fluid dispensing orifices which are spaced out along the width of the elongated elastomeric contact member such that when fluid is dispensed, a wide flat application of fluid can still be deposited. The fluid dispensing orifices can be round, oval, triangular, square, rectangular in shape, or combinations thereof. In one embodiment, the portion of the elongated elastomeric contact member leading up to the fluid dispensing orifice forms a tapered exit channel, the tapering can be tapered in, or tapered out. Without intending to be bound by theory, it is believed that a tapered exit channel, particularly one that tapers out so the cross sectional area of the orifice is larger that the cross sectional area of the channel leading to the orifice, can be useful to ease in removal of any fluid which can reside in the vicinity of the orifice after use. A tapered in exit channel may be useful to minimize exposure of the fluid to contact with air, thereby minimizing fluid dry out.

### One-Way Valve

In one preferred embodiment, the one-way valve is formed from the elastomeric material forming said at least one dispensing orifice, described herein as an elongated elastomeric one-way valve. Without intending to be bound by theory, it is believed that this an embodiment comprising an elongated elastomeric one-way valve is particularly useful to minimize undesirable backflow of fluid or other materials such as hair or skin particles, bacteria or other microbials back into the fluid flow path. Further, by providing an elongated elastomeric one-way valve, materials can be minimized as there may not be a need for multiple one-way valves to be included at various points along the fluid flow path.

The one-way valve is preferably biased to be in a closed position until it is actuated and thereby opened. In one embodiment, where an elongated elastomeric one-way valve is formed in said fluid dispensing member, the one-way valve can be actuated via physical contact with skin or another surface such that the elastomeric contact region deforms and allows the one-way valve to open. This is believed to be particularly useful as it minimizes the number of moving parts and user interactions required to dispense the fluid. In one embodiment, the one-way valve can be actuated by either movement of the shaving head, such as generally disclosed in U.S. Pat. No. 7,121,754, inter alia, at col. 1, line 45-col 2, line 24.

### Actuator

The actuator can be manual or automatic pump (battery powered or via an external power source). The pump includes a wall, either movable or rigid, upon which force is acted upon to move the fluid through. In the case of a movable wall, the movable wall may be located on one or more of an upper or lower surface of the handle. For a rigid wall, the force causes the movement of non-rigid sidewalls of the pump to move a fluid through to the channel.

In one embodiment, the actuator is a manually-actuated pump which can reside on the handle. In another embodiment, the actuator is automated and can be powered by a battery or external power source. In yet further embodiments, the actuator comprises a pump which is actuated by movement of the shaving head (such as where depression of the head or rotation of the head about the pivot axis), actuates the pump. In yet another embodiment, the fluid dispensing member itself can be spring loaded and retractable upon contact with a surface such as skin such that the movement of the fluid dispensing member can act as the actuation to actuate the pump. Those of skill in the art will understand that in this type of embodiment, it could be preferred to have the elongated elastomeric contact region extend beyond the general plane of the shaving head such that when the device is brought into contact with a surface (such as skin) the fluid dispensing member will be pushed back towards the razor prior to surface contact with the shaving head. The movement of the fluid dispensing member can then actuate the pump permitting fluid to escape or be driven out of the cavity through the fluid flow path, out of the at least one dispensing orifice, ultimately onto the skin.

Other features and advantages of the invention will be apparent from the description and drawings, and from the claims.

FIGS. 1-4 provide side views of hair removal devices which are in accordance with at least one embodiment of the present invention. Hair removal device (100) is suitable for dispensing a fluid during the hair removal process, such as shaving. The hair removal device (100) includes a handle (200) and a hair removal head (600), such as a disposable razor cartridge. Hair removal head (600) includes a top portion (610) and a bottom portion (620). Those of skill in the art will understand that the hair removal device can be a wet or dry, manual or powered razor, having straight or rotary blades. In addition, the hair removal device can be used with a depilatory, therefore not requiring the use of razor. The handle (200) has a length (210) that extends from a proximal end (220) to a distal end (230) and a transverse centerline (240) which runs along the central axis of the handle. The handle comprises a cavity (300) for housing a fluid (350) disposed within the handle, and an actuator (400) adapted to displace the fluid from the cavity through a supply channel (450) to an opening (460) formed in said handle, such as towards the proximal end of the handle.

The hair removal device (100) includes a fluid dispensing member (500) comprising an elongated elastomeric contact region (510) forming at least one dispensing orifice (520) in fluid communication with said opening (460) formed in said handle (200). Said elongated elastomeric contact region comprises a lateral dimension (515), shown in FIG. 5, which is generally perpendicular to said transverse centerline (240) of the handle. The hair removal head also has a lateral dimension (625) which his generally perpendicular to said transverse centerline. In one embodiment, the ratio of the lateral dimension of the elongated elastomeric contact region (515) to the lateral dimension of the hair removal head (625) is from 1:10 to about 1.5:1, alternatively from about 0.5:1 to about 1:1. Without intending to be bound by theory, it is believed that by providing an elongated elastomeric contact region which is laterally sized with respect to the hair removal head as recited herein, the fluid dispensed from said at fluid dispensing member covers a sufficiently broad portion of said hair removal head to provide suitable product spreading over skin and into cracks and corners of the skin. The fluid dispensing member is in fluid communication with said cavity via said opening, forming a fluid dispensing path (540), wherein said supply channel and said fluid dispensing path form a fluid flow path (550).

In one embodiment, the elongated elastomeric contact region is positioned below said hair removal head when the hair removal device is positioned such that the top portion of the hair removal device is positioned higher than the bottom portion. Preferably, the hair removal head is in the vicinity of the bottom portion, meaning that the hair removal head is closer to the bottom portion than to the top portion. This embodiment is believed to be particularly useful to allow the fluid to dispense onto skin prior to the point where the hair removal head contacts the skin, such as when using shaving preparations hair removal waxes, other hair removal compositions, or depilatories (as disclosed in U.S. Pat. Nos. 4,618,344, 5,645,825A, 6,743,419, and US Patent Publication US2004/0228820A1). In another embodiment, the fluid dispensing member is positioned in the vicinity of the top portion of the hair removal head. This could be particularly useful if the fluid is a moisturizer or other skin care composition which can be applied after the hair removal process.

The hair removal device also includes at least one one-way valve (530) located at some point along said fluid flow path. As explained above, in some embodiments, said elongated elastomeric contact point forms said one-way valve. Additional one-way valves can also be included along the fluid flow path as desired.

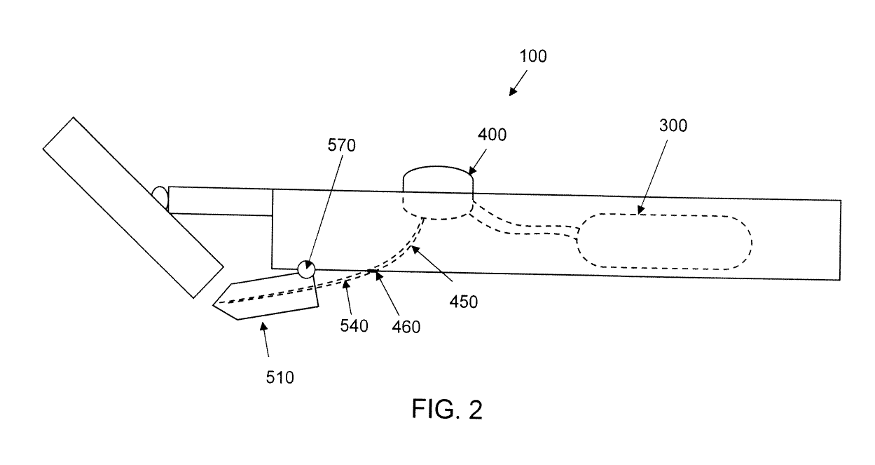

The actuators shown in FIGS. 1-4 are manual pumps but automatic pumps can also be included. The actuators shown in FIGS. 1-4, which can be manual or automatic, and may include pumps which can be stacked (and substantially flat) components and particularly a movable wall that acts to activate the flow of fluid from the cavity through channel and to the opening. A pump suitable for use in the present invention is disclosed in U.S. Pat. No. 5,993,180. In particular, this pump includes a pump chamber bounded by the movable wall, an inlet channel and an outlet channel, both of which are connected to the pump chamber, an inlet valve for closing the inlet channel, and an outlet valve for closing the outlet channel. The movable wall of the pump may take a number of forms. For instance, one movable wall embodiment may comprise a rigid topside that moves in the z-direction in response to a force acted upon the rigid topside that in turn causes non-rigid side walls of the pump to compress to move a fluid through the razor. In another instance of the present invention, the movable wall may comprise a rigid central region surrounded by a flexible periphery such that the movable wall's tactile characteristics vary within the single plane of the topside. In this instance the side walls may be either rigid or flexible. In another embodiment, the topside surface of the wall may be flexible such that the mere application of force to the flexible topside results in a “movable” wall that gives in response to such force. In most instances, the pump may be actuated by the pressure exerted by a user's finger such that the user may easily determine the requisite amount of fluid for one or more shaving strokes. Because the valves of the pump are automatically opened when pressure is applied by the user's finger pressure, the fluid can be dispensed in controlled and metered quantities without relying on judgment or dexterity of the user. It is also possible to place one or more movable walls of the pump on an upper surface or lower surface of the razor depending on a user's preference. The actuator of FIG. 1 is shown providing a feed into the cavity. This feed can be application of pressure or another impulse which will drive fluid through said fluid flow path out to the fluid dispensing member. The actuator shown in FIG. 2, however, has a receiving chamber where fluid is transferred prior to entering the supply channel and passing into the fluid dispensing member. These and other actuators and pumps which are known in the art for use in personal care devices which dispense fluids can be used in accordance with the present invention.

The cavity (300), or at least a container/sachet within the cavity (300), contains the fluid (350) to be dispensed during the hair removal process. In one embodiment, the fluid (350) in the cavity or container is refillable or replaceable. The container may have multiple chambers that allow fluids to mix upon being dispensed. The fluid may include shaving gels, shaving foams, shaving lotions, skin treatment compositions, conditioning aids, depilatories, lotions, moisturizers, etc., all which may be used to prepare the skin's surface prior to the engagement of the hair removal head with the skin, in particular either the blade if shaving or a rigid hair removal member when using depilatories. Additionally, such materials may comprise benefit agents suitable for skin and/or hair that may be useful for a number of different desirable effects including exfoliation, cooling effects, cleansing, moisturizing, warming or thermogenic effects, conditioning, and the like. Suitable benefit agents for skin and/or hair for inclusion into the fluid of the razor are disclosed in U.S. Pat. No. 6,789,321. For instance, suitable agents include but are not limited to shaving soaps, lubricants, skin conditioners, skin moisturizers, hair softeners, hair conditioners, fragrances, skin cleansers, bacterial or medical lotions, blood coagulants, anti-inflammatories, astringents, and combinations thereof. In certain embodiments, the fluid may be contained in a sachet, either disposable or reusable, that is further contained within the cavity of the handle.

FIG. 2 provides a side view, where the fluid dispensing member is pivotably attached to said handle via a hinge member (570) positioned on said handle. Further, as shown in this figure, in one embodiment, a portion of the fluid flow path, such as the fluid dispensing path (540) can be exposed upon exiting said opening (460) formed in said handle.

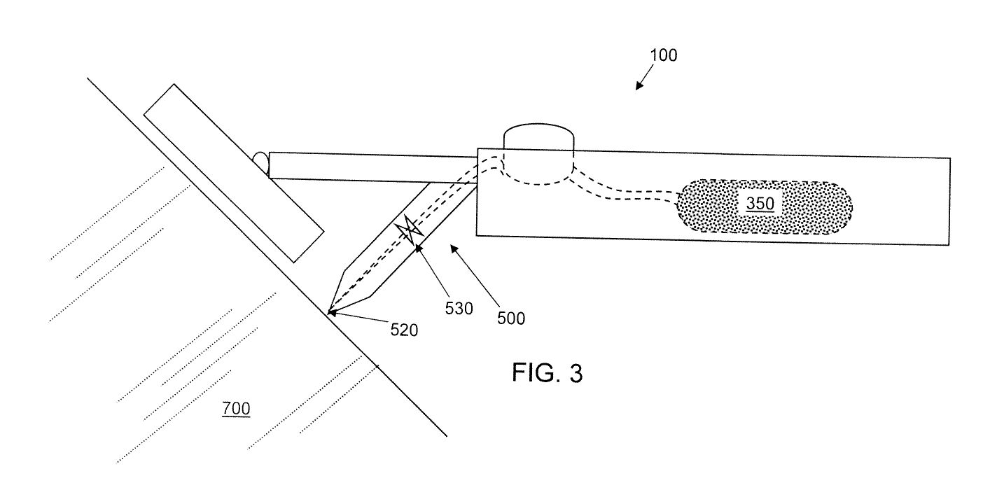

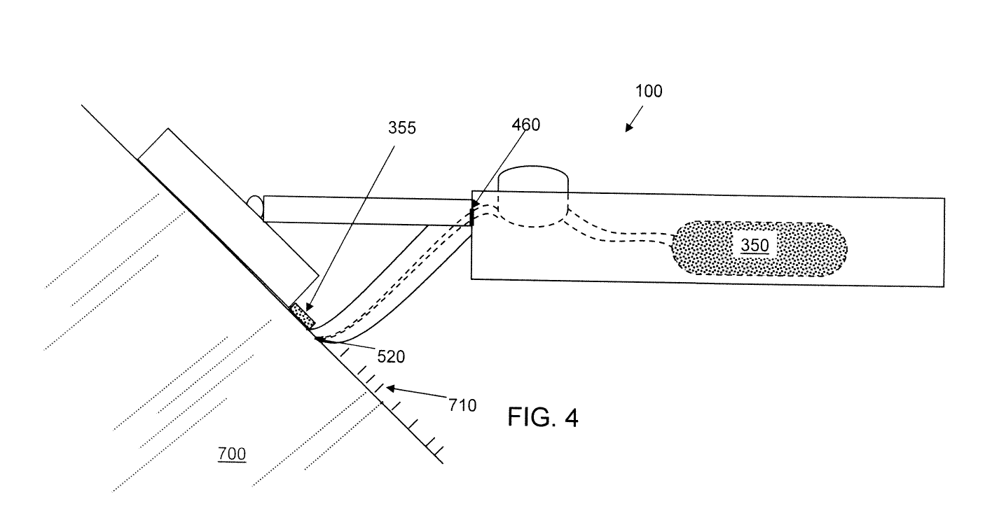

FIGS. 3 and 4 provide two exemplary side views of a hair removal device wherein the fluid dispensing member is shown deforming. In FIG. 3, the fluid dispensing member (500) is shown extending beyond the general facial plan formed by said hair removal head. Since the fluid dispensing member comprises an elastomeric contact region, the portion of the fluid dispensing member which extends beyond the plane of the hair removal head would deform, as generally depicted in FIG. 4 when the device comes in contact with a surface, such as skin (700). In FIG. 4, a fluid dispensing member is deformed when the device is in an “in-use” position, allowing fluid to exit the at least one dispensing orifice (520) formed in the elongated elastomeric contact region. The elongated elastomeric contact region can flex toward the hair removal head, flex away from the hair removal head and can even come into contact with a portion of the hair removal head, all depending on the movement of the device with respect to the surface. A volume of fluid (355) is deposited onto the skin and the hair removal head is moved in a downward trajectory along the skin to remove hairs (710) which have been treated with said fluid. Further, the one-way valve shown in FIG. 3 is positioned along the fluid flow path but not at the point where the fluid dispensing member forms said at least one dispensing orifice. Those of skill in the art will understand that the at least one one-way valve can be formed anywhere along the fluid flow path, including but not limited at the point of the at least one dispensing orifices. In one embodiment, a one-way valve can be provided at the opening between the handle and the fluid dispensing member. Furthermore, in one embodiment, the elongated elastomeric contact region is not in direct contact with the hair removal head when not in use. In one embodiment, the elongated elastomeric contact region is deformed such that it comes into direct contact with the hair removal head when in use. Additionally, the elongated elastomeric contact region can also be in direct contact with a portion of the hair removal head even when the device is not in use.

The cartridge (600) attaches to the rear surface of a housing (not shown) by a cartridge connecting structure (not shown). The cartridge connecting structure may include one or more arms that extend to provide pivotal support of the housing. Alternatively, the cartridge connecting structure may include an ejection mechanism (e.g., a button) to disengage the housing from the cartridge connecting structure. Non-limiting examples of suitable housings and cartridge connecting structures are described in: U.S. Pat. Nos. 7,197,825, 5,822,869, 6,161,287, and 5,784,790.

The razor cartridge (300) may also include a guard (330) or lubricating strip located between the top portion (204) and bottom portion (206). The guard (330) is useful for stretching the skin's surface immediately prior to engagement with the blade or a first blade (when more than one blade is present). This guard (330) may typically comprise an elastomeric member to allow for an engagement that is comfortable to a user. U.S. Pat. No. 7,168,173 discloses a suitable razor cartridge and elastomeric material without the apertures. The elastomeric material can be selected as desired. Typically, the elastomeric material used is a block copolymer (or other suitable materials), e.g., having a durometer between 28 and 60 Shore A.

The shaving aid, also known as a lubricating strip, on the other hand, provides an additional treatment to the skin after contact between the fluid and the skin has occurred. The lubricating strip may contain the same or additional skin ingredients to those that are present in the fluid. Suitable shave aids/lubricating strips are disclosed in U.S. Pat. Nos. 7,069,658, 6,944,952, 6,594,904, 6,182,365, D424,745, 6,185,822, 6,298,558 and 5,113,585. The cartridge connecting structure (312) may be releasably engaged from the handle (300), as disclosed in U.S. Pat. Nos. D533,684, 5,918,369, and 7,168,173. This disengagement of these two components allows for replacement of razor cartridges as the continued use of such cartridges causes blade dulling. Thus, such cartridges are replaceable and disposable at will by the user.

FIG. 5 provides a bottom planar view of a portion of a hair removal device in accordance with at lest one embodiment of the present invention. Hair removal head (600) is shown as a razor cartridge with a plurality of blades (650) and a shaving aid (640) as well as a guard (660). The razor cartridge is shown having a lateral dimension which can measure any length typically used for conventional straight blade wet razor cartridges, for example from about 2 cm to about 10 cm, alternatively from about 3 cm to about 8 cm, alternatively from about 4 cm to about 7 cm. A transverse centerline of the handle is shown as (240). Said elongated elastomeric contact region (500) comprises a lateral dimension (515) which is generally perpendicular to said transverse centerline. In this embodiment, two fluid dispensing orifices are shown (520). Those of skill in the art will understand that different fluid dispensing orifice configurations are within the scope of the invention. FIG. 5 shows two fluid dispensing orifices which are equal in length and are positioned linear to one another. The lengths can vary and the orifices can be staggered so they do not sit on the same line. Further, although the at least one fluid dispensing orifice is shown being generally parallel to the angle of the razor cartridge and/or blades, the orifice can be angled. The lateral dimension of the at least one fluid dispensing orifice (525) is measured as the greatest lateral distance covered by the orifice, regardless of the angle upon which the orifice sits with respect to the razor cartridge and/or blades. In another embodiment, the at least one fluid dispensing orifice can have a curved or wavy line shape. In one embodiment, the ratio of the lateral dimension of the at least one fluid dispensing orifice (525) to the lateral dimension of the hair removal head (625) is from about 1:10 to about 1:1, alternatively from about 1:5 to about 1:2.

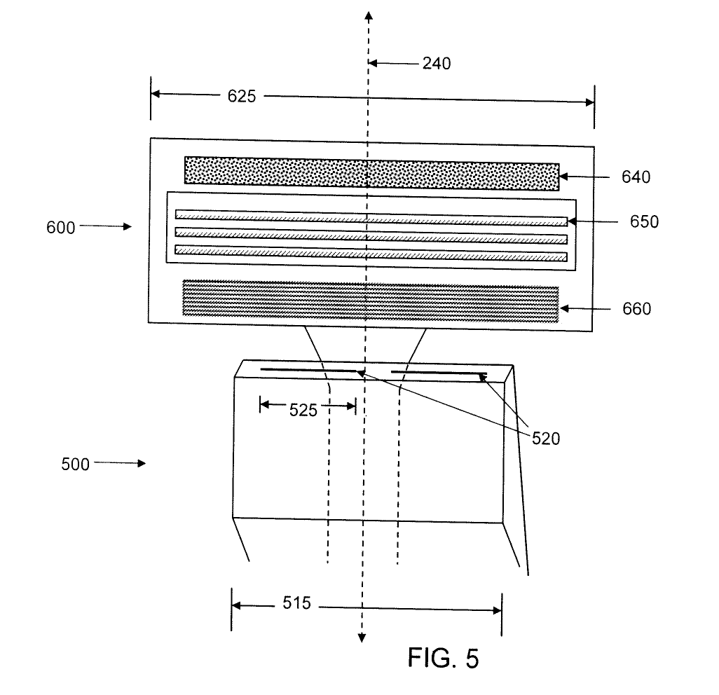

FIG. 6 provides a bottom planar view of a portion of a hair removal device in accordance with at least one embodiment of the present invention. The elongated elastomeric contact member is shown with a transverse central axis (540). The elongated elastomeric contact member, being deformable and elastic in nature can twist, bend, compress and stretch as needed. In this embodiment, the elongated elastomeric contact member has a rotation path (545) showing the ability of the elongated elastomeric contact member to rotate about said transverse central axis. In this embodiment, the portion of the elongated elastomeric contact member which forms the at least one fluid dispensing orifice (520) shown in a sealed position, has a greater lateral dimension than the portion of the elongated elastomeric contact member which would be closer to the handle. Those of skill in the art will understand that the elongated elastomeric contact member can have a constant, increasing or decreasing lateral dimension as the lateral dimension is measured from the distal end to the proximal end (towards the handle).

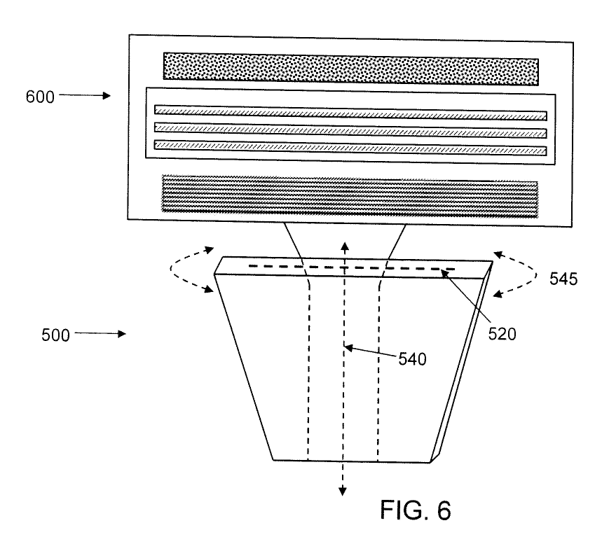

FIG. 7 shows another hair removal device in accordance with at least one embodiment of the present invention. In this embodiment, both the tip of the fluid dispensing member (500) and the at least one fluid dispensing orifice (520) are concave shaped so they can contour to body parts easier. The at least one fluid dispensing orifice is shown having a lateral dimension (525). This could be particularly preferable for female hair removal devices which are designed for use on the leg or arms. In this embodiment, the hair removal head (600) is shown having a scraping edge (680). The hair removal head can also be a razor cartridge as described above.

In one embodiment, the hair removal head has a skin contacting edge which is flat, concave or convex. Those of skill in the art will understand that different shapes for the skin contacting edge can be preferred based on the desired part of the body upon which the device is intended for use. For example, a hair removal device intended for use on the face may have an applicator having a straight edge. A hair removal device intended for use on legs may have an applicator having a concave edge. Non-limiting examples of suitable head configurations are disclosed in U.S. Pat. Nos. D399,601, D203,892, and 651,420 to Haglock; U.S. Pat. Nos. 3,088,470, 3,858,985, and 2004 0168743A1 to Garwood; WO Publ. No. 97/18043A1 to Weiss; and GB 1 390 153 to Laboratorio Guidotti & C. S.p.A.

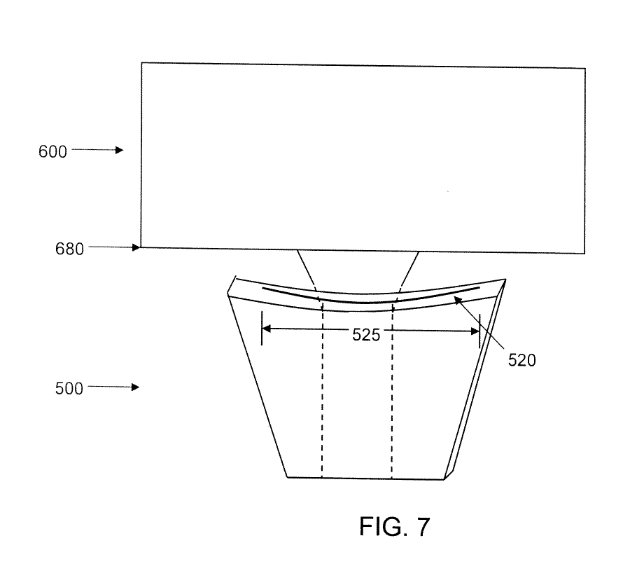

FIG. 8 provides an exploded side view of a fluid dispensing member (500) wherein the fluid dispensing member has an angled and tapered distal region (extending away from the handle). An fluid dispensing orifice (520) is shown in fluid communication with the fluid flow path (550). In one embodiment, a check valve is provided along the fluid flow path. In another embodiment, the fluid dispensing orifice can include a flap or be designed to close when not in use. The fluid dispensing orifice could then act as a one-way valve as described above. In one embodiment the fluid flow path has a constant cross sectional area or a varying cross sectional area. The fluid flow path shown in FIG. 8 is tapered as it approaches the fluid dispensing orifice.

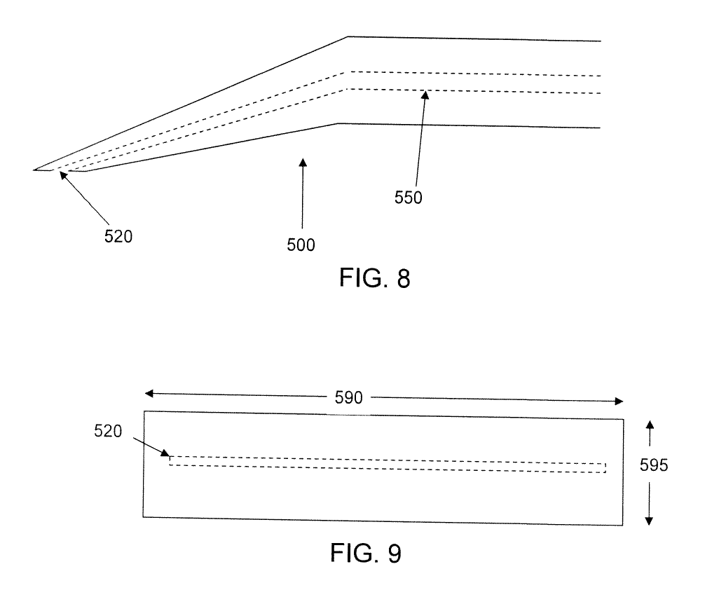

FIG. 9 provides a planar view of the contact region which engages skin during use of a fluid dispensing member. The fluid dispensing orifice (520) is shown in dashed lines as it can be sealed when not in use. The width of the fluid dispensing member (590) is shown as well as the height of the fluid dispensing member (595). In one embodiment, the fluid dispensing orifice has a width of from about 2 cm to about 15 cm, alternatively from about 3 cm to about 10 cm, alternatively from about 4 cm to about 8 cm. Where numerous fluid dispensing members are provided, the width can be even smaller, as low as about 0.2 cm, or about 0.5 cm, or about 1 cm. The width of the fluid dispensing orifice is preferably 0 cm when the device is in a sealed state (not in use) but the width can change when the orifice is opened and can be from about 0.02 cm to about 0.5 cm, alternatively from about 0.05 cm to about 0.3 cm, alternatively from about 0.1 cm to about 0.2 cm. In one embodiment, the fluid dispensing orifice is not 0 cm when not in use. In this embodiment, a check valve can be included somewhere along the fluid flow path to control movement of the fluid before it reaches the fluid dispensing orifice. In another embodiment, the fluid dispensing orifice comprising a width of from about 0.5 mm to about 10 mm, or from about 1 mm to about 3 mm, and a length of from about 20 mm to about 80 mm, or from about 30 mm to about 70 mm, alternatively from about 40 mm to about 50 mm.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern.

Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hair removal device comprising:
a. a handle having a length that extends from a proximal end to a distal end and a transverse centerline, the handle comprising
i. a cavity for housing a fluid disposed within the handle, and
ii. an actuator adapted to displace the fluid from the cavity through a supply channel to an opening formed in said handle;
b. a fluid dispensing member comprises an elongated elastomeric contact region forming at least one dispensing orifice in fluid communication with said opening, said elongated elastomeric contact region comprising a lateral dimension which is generally perpendicular to said transverse centerline, wherein said fluid dispensing member is in fluid communication with said cavity via said opening, forming a fluid dispensing path, wherein said supply channel and said fluid dispensing path form a fluid flow path;
c. at least one one-way valve located at some point along said fluid flow path; and
d. a hair removal head having a lateral dimension.

2. The hair removal device of claim 1, wherein the ratio of the lateral dimension of the elongated elastomeric contact region to the lateral dimension of the hair removal head is from 1:10 to about 1.5:1.

3. The hair removal device of claim 2, wherein said ratio of the lateral dimension of the elongated elastomeric contact region to the lateral dimension of the hair removal head is from about 0.5:1 to about 1:1.

4. The hair removal device of claim 1, wherein said hair removal head has a top portion and a bottom portion, and wherein said elongated elastomeric contact region is positioned below said hair removal head in the vicinity of said bottom portion.

5. The hair removal device of claim 4, wherein said elongated elastomeric contact region is not in direct contact with said bottom portion of said hair removal head in a resting position.

6. The hair removal device of claim 4, wherein said elongated elastomeric contact region flexes towards said bottom portion of said hair removal head in an in-use position.

7. The hair removal device of claim 4, wherein said elongated elastomeric contact region is in direct contact with said bottom portion of said hair removal head in an in-use position.

8. The hair removal device of claim 4, wherein said elongated elastomeric contact region has a transverse central axis and rotates with respect to said transverse central axis.

9. The hair removal device of claim 4, wherein the ratio of the lateral dimension of the elongated elastomeric contact region to the lateral dimension of the hair removal head is from 1:10 to about 1.5:1.

10. The hair removal device of claim 1, wherein said hair removal head has a top portion and a bottom portion, and wherein said elongated elastomeric contact region is positioned below said hair removal head in the vicinity of said top portion

11. The hair removal device of claim 1, wherein said elongated elastomeric contact region forms said one-way valve.

12. The hair removal device of claim 11, wherein said one-way valve is selected from a flap valve, a slit valve, a duckbill valve, and a combination thereof.

13. The hair removal device of claim 1, wherein said elongated elastomeric contact region is separated from said one-way valve.

14. The hair removal device of claim 1, wherein said at least one dispensing orifice has a lateral dimension, wherein the ratio of the lateral dimension of the at least one dispensing orifice to the lateral dimension of the hair removal head is from 1:10 to about 1:1.

15. The hair removal device of claim 1, wherein said at least one dispensing orifice is biased to be sealed in a resting position.

16. The hair removal device of claim 15, wherein said at least one dispensing orifice opens when in an in-use position.

17. The hair removal device of claim 1, wherein said one-way valve is actuated by at least one of movement of the hair removal head, actuation of said pump, and a combination thereof.

18. The hair removal device of claim 1, wherein said fluid dispensing member is hingedly attached to said proximal end of said handle.

19. The hair removal device of claim 1, wherein said hair removal head comprises a razor cartridge.

20. The hair removal device of claim 1, wherein a hair removal composition is contained within said cavity, said hair removal composition being selected from shaving gels, shaving foams, shaving lotions, skin treatment compositions, conditioning aids, depilatories, lotions, moisturizers, and mixtures thereof.
